(19) United States
(12) Patent Application Publication
(10) Pub. No.: US 2006/0155392 A1
(43) Pub. Date: Jul. 13, 2006

(54) Method and a tool for allocating computational resources in a distributed control system

(75) Inventors: Alexander Fay, Weinheim (DE); Fabrizio Lorito, Milano (IT); Stefano Poretta, Villa Guardia (IT); Rolf Vahldieck, Minden (DE); Peter Wendt, Garbsun (DE)

Correspondence Address: CONNOLLY BOVE LODGE & HUTZ LLP, SUITE 800, 1990 M STREET NW, WASHINGTON, DC, 20036-3425, US

(73) Assignee: ABB Research Ltd., urich (CH)

(21) Appl. No.: 10/559,080

(22) PCT Filed: Jun. 2, 2003
(86) PCT No.: PCT/EP03/05874

§ 371 Date: Dec. 2, 2005

(30) Foreign Application Priority Data
Jun. 11, 2003 (EP) 03101696.7

(51) Int. Cl. G05B 11/01; G05B 19/42

(52) U.S. Cl. 700/18; 700/19; 700/86; 700/87

(57) ABSTRACT

The invention concerns method and a tool for designing an optimal hardware structure of a process control system and configuring a given control function onto the optimal hardware structure of the process control system. The method and the tool of the invention comprises three main parts that can be used in conjunction or be used separately together with other solutions for the remaining part or parts of the system.

### TECHNICAL FIELD

The invention relates to process control, monitoring and automation systems for industrial and manufacturing plants. In particular it refers to tools and methods for enabling and facilitating the designing and configuration of process control systems.

### BACKGROUND ART

A process control system is normally composed by several components with different scope. As an example we can consider a process control system to comprise one or more:

operator stations to allow the operator to interact with the controlled process (e.g. to monitor the process and to activate actions on the process);

engineering stations to allow the process engineer to configure the process control system off-line or on-line;

controllers. Controllers are microprocessor-based components that acquire digital or analogue data from the process, and/or from the operator station, and generate outputs to the process or to the operator station. Controllers are normally programmable, including the traditional type used in certain industries known as a Programmable Logic Controller (PLC). The control strategies for the plant process are normally executed in the microprocessors of the controllers. The controllers are normally also provided with suitable input and output to manage and digitise analogue signals where necessary from and to the controlled process;

digital networks connecting the operator stations, the engineering stations and the controllers;

microprocessor or non-microprocessor based field devices which acquire analogue or digital data from the controlled process e.g. pressure sensors, temperature sensors, or to actuate action to the process, e.g. valve positioners, switches, variable speed drives;

digital control network(s) to connect microprocessor-based field devices to other microprocessor-based field devices, or to the controllers, or directly to the operator station(s) or the engineering station(s);

cabling of different types to connect the non-microprocessor based field devices to suitable input and output ports present in the controllers.

It should be noted that field devices are traditionally relatively simple devices which are controlled either manually or electronically and which produce output readings either electronically or displayed on a gauge connected to the device. These devices typically provide only limited information to a controller, restricted mainly to analogue signals related to the readings or measurements made by these devices. This information is traditionally generated as analogue signals, usually conforming to general standards, usually an analogue output of between 4-20 mA. Later devices may include analogue/digital (A/D) converters or other means such that the devices produce a digital output signal, typically from 0-24V and with a maximum digital output current of 0.5 A. In recent years so called “smart” field devices have been developed. Such smart field devices are capable of communicating not only with a process controller but also with a management system associated with the device. Typically smart field devices, as well as transmitting an analogue signal related to, for example, a measurement value, may also store and also digitally transmit detailed information, such as calibration, configuration, diagnostic, maintenance and/or process information relevant to the smart device and/or its control function. It is an advantage to have field devices that are smart devices which may, for example, signal in addition whether the device is operating correctly, troubleshooting information about the device, how and when to calibrate the device, etc. However the signals generated by traditional field devices and the signals generated by smart devices are fundamentally different and have usually been handled by different communication or data network standards. Setting up and configuring a control system that includes both traditional field devices and smart devices is a complex challenge.

It should be noted that smart field devices, being equipped with a microprocessor, can also serve as small controllers in the process control system, i.e. control functions can be carried out on the microprocessor of the field device instead or in addition to the control functions carried out in the controller.

Recently, “remote I/O” interfaces have appeared on the market as further components of process control systems. These remote I/O interfaces serve as a link between conventional field devices (with analog communication) and a fieldbus connection to a controller. Remote I/O can also be equipped with controllers themselves, e.g. a PLC, being also able to carry out control functions, like the controllers.

The above description points out that control functions can be carried out on different types of components of the process control system. A process control system typically consists of several components of different types. Thus, the complete control function, i.e. the complete set of all the control functions to be carried out in the process control system, can be distributed to a variety of components. The task of distributing the complete control functions on the available components has to take into account constraints such as:
the performance of the control components, i.e. memory,
vs. the requirements of the control functions regarding memory;
the performance of the communication links between the components
vs. the requirements of the control functions regarding communication behaviour (e.g. communication delay and determinism).

Therefore, the optimal distribution of the complete control function to the various components of a process control system is a difficult task and becomes even more difficult with the above listed tendencies regarding an increasing number of components with controller-capability.

The development cycle for the engineering of process control systems (such as automation of refineries, power plants, automobile manufacturing plants etc.) is variable, depending on different contexts, but generally it consists of several steps. Each step may be tackled with supporting tools and/or manually by different process engineers or control engineers or information technology engineers, depending on the level of detail required for that part of the engineering process. One of the steps is that the complete control function has to be designed. Another step is the design of the process control system hardware structure, comprising of the components listed above. Another step is the distribution of the control functions (the software) on the process control system hardware structure.

In process control systems, the different types of controllers, remote I/O and devices and the different types of communication means, e.g. different fieldbuses, have different features regarding how they can execute control functions or communicate signals, thus offering different performance for control functions. Therefore, the state of the art is that, the process control system hardware structure is decided upon rather early in the workflow, and before the design of the control functions. The design of the control functions is then usually carried out together with the distribution of the control functions to the process control system hardware structure. The advantage of this kind of workflow is that the control functions can be designed based on the already defined hardware structure and software distribution. Thus, the control function design can take into account the specific features of the different components of the process control system hardware. On the other hand, the state-of-the-art workflow has the disadvantage that the design of the control functions is not independent of the hardware system design. Thus, a later change in the hardware structure, as might become necessary due to changes in the available technology (new components, new communication means, and so on) requires a re-write of the control functions, because they are implementation-dependent.

In U.S. Pat. No. 6,411,923 is described a method for analyzing a process control network design to meet criteria of a standard protocol. The method included a software analysis tool having access to information regarding standard protocol criteria including a length of the bus, a cable type of the bus and a voltage requirement of the field device for analysis by the tool to assure that the process control network design conforms to the criteria of the standard protocol. An advantage of this system is that it allows for an efficient design of a process control system while ensuring that the physical characteristics of the system conform to standard.

The distribution of the control functions to the process control system hardware structure as well as a possible later re-distribution of the control functions to a new process control system hardware structure in case of failure of a component is a difficult task that is not resolved in the prior art.

### SUMMARY OF THE INVENTION

The invention solves one or more of the above problems. One aspect of the invention is a method for designing and configuring a system for process control, monitoring and automation of industrial and manufacturing plants.

In another aspect of the invention a software tool is provided for carrying out the methods of the invention.

The principle advantage of the invention is that a control engineer may design and configure the complete control function of a process control system without taking into consideration the underlying process control system hardware structure and its technical characteristics regarding memory and communication, because the method of the invention automatically designs an optimal hardware structure and distributes the control functions that make up the complete control function onto the optimal hardware structure, ensuring that the requirements are met or, if they cannot be met due to limitations, this is notified to the control engineer, which can either change the hardware structure and its components or change the control functions or relax the requirements. Thus, design and distribution of the control function can be largely decoupled from the actual hardware structure.

In the context of process control, monitoring and automation systems for industrial and manufacturing plants, the invention is particularly concerned with the methods carried out at the engineering station(s). The engineering process that begins with the definition of the plant and plant areas, includes the definition and design of control strategies, the definition and design of the HW/SW architecture, and the design and distribution of the executable control code that runs in the:

operator station(s) during plant operation,

controller(s),

the field device(s), and

in the network(s).

A basis of this invention comprises process control systems with distributed computational resources and the task is to design a system with an HW/SW configuration that allows different SW configurations in the different HW capabilities of the system itself. As soon as a fault occurs in a HW component of the system, the tool reconfigures the whole system and the application software is shared in different HW components to recover the performance of the system.

The method and tool of the invention comprise three main parts that each can be used separate or combined with one of the other parts in a system comprising other solutions for solving the remaining steps of designing or configuring a process control system. The main parts are a method and a tool for designing an optimal hardware structure for a given control function, a method and a tool for automatically distributing the given control function onto a given hardware structure in an optimal way and a method and a tool for automatically implementing the functions and parameters for a given hardware structure a control function distribution.

### BRIEF DESCRIPTION OF THE DRAWINGS

A more complete understanding of the method and system of the present invention may be had by reference to the following detailed description when taken in conjunction with the accompanying drawing wherein:

FIG. 1 is a schematic block diagram representing a process control system hardware structure.

FIG. 2 is a flow chart showing the operation of a design and configuration tool.

### DETAILED DESCRIPTION

While the design and configuration method and the tool therefore of this invention are described in detail in conjunction with a heterogeneous process control system containing certain hardware and software components including traditional field devices and smart field devices, it should be noted that the invention is not limited to such specific set of HW or SW components and that each part of the method and tool can be used together with other solutions for solving the remaining parts.

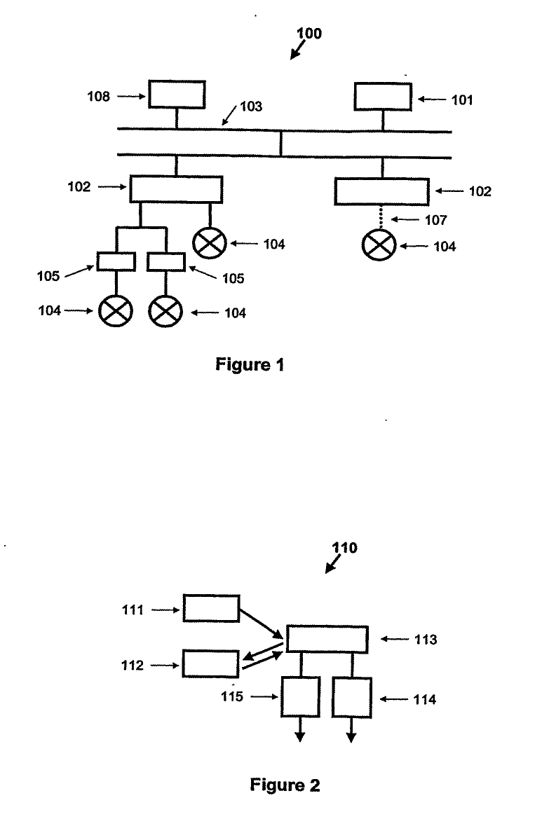

FIG. 1 shows a the hardware structure of a process control system 100 in which an operator station 101 is connected to distributed process controllers 102 via a digital network 103. The process controllers 102 are communicating with a number of field devices 104 that may include processing capability or remote I/O 105 via a digital control network 106 or via a wireless connection 107. An engineering station 108 provides the management of the heterogeneous process control system. The invention is applicable for configuration any of component of a process control system and can include digital control networks like PPOFIBUS FBs, Fieldbus Foundation FBs, Hart Device FBs, HSI functions and controller function blocks (FBs), functions, modules circuits etc.

In FIG. 2 is shown a flow chart for a design and configuration tool 110 which allows management of the distributed computational resources.

The tool 110 for designing and configuring an process control system comprises the following components:

A tool 111 that allows to describe in a functional way the control logics and the regulations of the plant thus designing a complete control function for the process control system.

A software library 112 where all the computational products, such as field devices and controllers, are present with their computational capability and description.

An automatic tool 113 that starting from the complete control function and searching the library, defines possible optimal HW structures for the process control system. When the tool has chosen an optimal HW structure it creates a bill of materials for the chosen system (not shown in the figure). It is also possible for a process engineer to review the optimal HW structure and make changes or accept it as it is( not shown in the figure). In case the process engineer makes manual changes to the structure, the bill of material will be issued after the changes have been introduced.

A distribution tool 114 which starting from the chosen hardware structure automatically generates code and configures it to the hardware and software components of the system. Depending on the type of the individual component chosen in the previous phases, this tool effectively generates executable code and/or switches on or off executable code already present in the controllers or field devices or other components.

After the HW structure has been decided upon and the software functions of the complete control function have been configured onto the HW, the communication system is configured by means of the addressing tool for assignment 115, i.e. HW addresses are set for all components of the system and communication details like cycle times, poll cycles, communication token orders etc are configured.

The automatic tool 113 can force certain solutions or constraints typical of a specific application such as redundancy, spare parts, etc.

An additional feature in case of redundancy being a constraint is that the tool has the capability of exploiting the intrinsic redundancy present in a fieldbus system in order to have effective redundancy during operation.

All tools described are able to work both with process control systems with intelligent field devices and/or with field devices linked to a field bus network.

An advantage of the invention is that the control function can be designed independent of the technology of the hardware structure (e.g. conventional wiring, fieldbus, smart devices, remote I/O, or a mixture of all). This makes it possible to change the hardware structure during the lifecycle of the plant without changing the control functions. The design of the complete control function remains untouched, which is a great advantage, since this ensures that the plant will continue operation properly and smoothly afterward a change of the hardware structure.

The design of the different control functions among the different distributed hardware resources normally aims for an optimal distribution, matching the requirements regarding memory and communication to the characteristics of the components of the hardware structure.

The distribution algorithm takes into account HW costs, HW speed, communication bandwidth and communication speed, real-time criteria ( e.g. no hard real-time communication, such as a fast control loop being closed via non-deterministic communication in for example an Ethernet), computation needs (memory and time) of the control functions, proximity to sensors and actuators (resulting in cable lengths), and further criteria; all criteria can be switched on and off and weighted against each other by the user. The complete control function and its computation needs are mapped against possible HW structures. Both the requirements and the features of the HW structures are characterized by numbers which are representing “costs”. For example, consumption of bandwidth is a kind of “cost”. Thus, the problem is boiled down to a multi-criteria-optimisation, with some hard constraints, such as memory limitation and some soft constraints, such as HW “costs”.

1-27. (canceled)

28. A method for designing and distributing a process control system, wherein the control system comprises a software structure and a hardware structure including components comprising field devices, controllers, linking devices, the method comprising:
using a predefined complete control function and searching a software library comprising computational capability and description characteristics of hardware components and automatically designing an optimal hardware structure for the process control system;
automatic generation of executable code and configuration of the complete control function on to the designed optimal process control hardware structure; and
automatic assignment of HW addresses and configuration of the linking devices.

29. A method for automatic design of an optimal hardware structure for a given control function for a process control system, the method comprising:
using the given control function and searching a software library comprising computational capability and description characteristics of hardware components; and
automatically designing an optimal hardware structure for the process control system responsive to the search results.

30. A method for automatic distribution of a given control function onto a given hardware structure of a process control system, the method comprising automatically generating and distributing executable code of the given control function on to the given process control hardware structure.

31. A method for implementing a communication function for a given control function for a given process control hardware structure, the method comprising automatically assigning HW addresses and configuring linking devices.

32. The method of claim 29, further comprising automatically distributing the given control function onto the optimal hardware structure of the process control system by automatic generation of executable code and distribution of the given control function on to the optimal process control hardware structure.

33. The method of claim 29, further comprising implementing a communication function after distribution of a given control function onto the optimal hardware structure by automatic assignment of HW addresses and configuration of linking devices.

34. The method of claim 30, further comprising implementing a communication function for the given control function for the given process control hardware structure by automatic assignment of HW addresses and configuration of linking devices.

35. The method of claim 28, wherein the automatic configuration includes switching on or off executable code already present in field devices.

36. The method of claim 28, wherein the automatically designed optimal hardware structure is shown in such a way that it is capable of being altered by an operator before the generation of code and configuration takes place.

37. The method of claim 28, further comprising issuing a bill of material after the optimal process control hardware structure has been designed either automatically or after alteration by an operator.

38. The method of claim 28, wherein a configuration algorithm takes into account HW costs, HW speed, communication bandwidth and communication speed, real-time criteria, computation needs including memory and time, of the control functions as well as proximity to field devices including sensors and actuators.

39. The method of claim 28, wherein the process control system hardware structure comprises both wired and non-wired field devices.

40. A method for designing and configuring a process control system in operation after a failure of a component, wherein the control system comprises a complete control function, a software structure and a hardware structure including components including field devices, controllers, linking devices, the method comprising:
automatically detecting a failure of a hardware component; and
using the complete control function and searching a software library comprising computational capability and description characteristics of hardware components;
automatically designing a new optimal hardware structure for the process control system excluding the failed hardware component;
automatically generating executable code that distributes the control function to the new hardware structure; and
automatically assigning HW addresses to new components of the hardware structure and configuring the linking devices.

41. A computer-implemented device for defining and configuring computational resources in a process control system, wherein the control system comprises a software structure and a hardware structure including field devices, controllers, and linking devices, the tool comprising:
a software library comprising computational capability and description characteristics of hardware components useful to automatically design an optimal hardware structure for a given process control function;
an automatic tool starting from the complete control function that searches the software library and automatically designs an optimal hardware structure for the process control system;
a distribution tool that automatically generates executable code and configuration of the complete control function on to the designed optimal process control hardware structure; and
a tool that automatically assigns HW addresses and configuration of the linking devices.

42. A system for automatic design of an optimal hardware structure for a given control function for a process control system, the automatic design system comprising:
an automatic tool, wherein the automatic tool uses the given control function and searches a software library comprising computational capability and description characteristics of hardware components, and automatically designs an optimal hardware structure for the process control system responsive to search results.

43. An apparatus for automatic distribution of a given control function onto a given hardware structure of a process control system, the apparatus comprising a distribution tool that automatically generates executable code and distributes the given control function on to the given process control hardware structure.

44. An apparatus means for implementing a communication function for a given control function for a given process control hardware structure, the apparatus comprising tool that automatically assigns HW addresses and configuration of linking devices.

45. The apparatus of claim 42, further comprising means for automatic distribution of the given control function onto the given hardware structure of the process control system, wherein the means for automatic distribution comprises a distribution tool that automatically generates executable code and distributes the given control function onto the given process control hardware structure.

46. The apparatus of claim 42, further comprising means for implementing a communication function for a given control function for a given process control hardware structure, wherein the means for implementing comprises a tool that automatically assigns HW addresses and configuration of linking devices.

47. The apparatus of claim 43, further comprising means for implementing a communication function for a given control function for a given process control hardware structure, wherein the means for implementing comprises a tool that automatically assigns HW addresses and configuration of linking devices.

48. The computer-implemented device of claim 41, wherein the tool that automatically assigns HW addresses and configuration of the linking devices includes means for switching on or off executable code already present in field devices.

49. The system of claim 42, further comprising means for showing an automatically designed optimal hardware structure and means for altering the structure by an operator before generation of code and configuration takes place.

50. The computer-implemented device of claim 41, wherein the software library includes predefined constraints on parameters characterizing hardware components of the control system including spare parts and cost parameters.

51. The computer-implemented device of claim 50, wherein the automatic tool includes capability of exploiting intrinsic redundancy present in a fieldbus system in order to ensure effective redundancy during operation.

52. The computer-implemented device of claim 41, further comprising:
means for generating a new hardware structure based on non-failing parts of the system; and
means for automatically distributing the control function on to the new hardware structure in response to a failure of a hardware component or corresponding software.

53. The computer-implemented device of claim 41, further comprising means for issuing a bill of material after an optimal process control hardware structure is designed.

54. The computer-implemented device of claim 41, wherein a configuration algorithm of the distribution tool takes into account factors comprising HW costs, HW speed, communication bandwidth, communication speed, real-time criteria, memory, and processing time of the given process control function and proximity to field devices including sensors and actuators.

55. The method of claim 29, wherein the automatic configuration includes switching on or off executable code already present in field devices.

56. The method of claim 30, wherein the automatic configuration includes switching on or off executable code already present in field devices.

57. The method of claim 29, wherein the automatically designed optimal hardware structure is shown in such a way that it is capable of being altered by an operator before the generation of code and configuration takes place.

58. The method of claim 29, further comprising issuing a bill of material after the optimal process control hardware structure has been designed either automatically or after alteration by an operator.

59. The method of claim 29, wherein a configuration algorithm takes into account HW costs, HW speed, communication bandwidth and communication speed, real-time criteria, computation needs including memory and time, of the control functions as well as proximity to field devices including sensors and actuators.

60. The method of claim 30, wherein a configuration algorithm takes into account HW costs, HW speed, communication bandwidth and communication speed, real-time criteria, computation needs including memory and time, of the control functions as well as proximity to field devices including sensors and actuators.

61. The method of claim 29, wherein the process control system hardware structure comprises both wired and non-wired field devices.

62. The method of claim 30, wherein the process control system hardware structure comprises both wired and non-wired field devices.

63. The method of claim 31, wherein the process control system hardware structure comprises both wired and non-wired field devices.

64. The system of claim 42, wherein the software library includes predefined constraints on parameters characterizing hardware components of the control system including spare parts and cost parameters.
